(19) United States
(12) Patent Application Publication
(10) Pub. No.: US 2010/0178645 A1
(43) Pub. Date: Jul. 15, 2010

(54) PARTICIPANT RESPONSE SYSTEM WITH QUESTION AUTHORING/EDITING FACILITY

(75) Inventors: TACO VAN IEPEREN, Calgary (CA); Michael Boyle, Calgary (CA); Zhaohui Xing, Calgary (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: SMART Technologies ULC, Calgary (CA)

(21) Appl. No.: 12/732,618

(22) Filed: Mar. 26, 2010

Related U.S. Application Data
(63) Continuation of application No. 12/522,836.
(60) Provisional application No. 60/879,573, filed on Jan. 10, 2007.

(51) Int. Cl. G09B 7/00

(52) U.S. Cl. 434/323; 434/362

(57) ABSTRACT

A participant response system (50) comprises processing structure (52) running an assessment during which participants are prompted to respond to one or more information requests. The processing structure executes a question authoring/editing facility to enable test question authoring that comprises a monitoring tool for monitoring questions during editing to inhibit creation of invalid questions. At least one display device communicates with the processing structure and is operable to display graphically authored test questions.

### RELATED APPLICATIONS

This application is a continuation of U.S. patent application Ser. No. 12/522,836, filed Jul. 10, 2009, which is a 371 of International Appln. No. PCT/CA2008/000044, filed Jan. 10, 2008, which claims the benefit of U.S. Provisional Patent Application Ser. No. 60/879,573 to Van Ieperen et al. filed on Jan. 10, 2007 entitled “Participant Response System with Question Authoring/Editing Facility”, the contents of all incorporated herein by reference.

### FIELD OF THE INVENTION

The present invention relates generally to a participant response system and in particular to a participant response system with question authoring/editing facility.

### BACKGROUND OF THE INVENTION

Participant response systems for enabling participants of an event to enter responses to posed questions, motions or the like are well known in the art and have wide applicability. For example, during a conference, seminar or the like, participants can be provided with handsets that enable the participants to respond to questions, or to vote on motions raised during the conference or seminar. In the entertainment field, audience members can be provided with handsets that enable the audience members to vote for entertainment programmes or sports events. These participant response systems are also applicable in the field of education. Students can be provided with handsets that enable the students to answer questions posed during lessons, tests or quizzes. Of significant advantage, these participant response systems provide immediate feedback to presenters, teachers, entertainment programme producers, or event organizers. With respect to the field of education, research shows that teachers teach better and students learn better when there is rapid feedback concerning the state of students' comprehension or understanding. It is therefore not surprising that such participant response systems are gaining wide acceptance in the field of education.

Participant response systems fall generally into two categories, namely wired and wireless participant response systems. In wired participant response systems, the remote units used by participants to respond to posed questions or to vote on motions are typically physically connected to a local area network and communicate with a base or host computer. In wireless participant response systems, the remote units used by participants to respond to posed questions or to vote on motions communicate with the host computer via wireless communication links. Whether wired or wireless, many different types of participant response systems have been considered.

For example, U.S. Pat. No. 2,465,976 to Goldsmith discloses a centercasting network system for polling public opinion by means of radio apparatus installed in numerous outlying voting stations. Groups of outlying voting stations communicate with associated central stations where votes that are obtained by the voting stations are counted or tabulated in accordance with any desired classification of votes. The voting stations gather and store voters' choices in a tangible medium. All of the voting stations within a given group then transmit the stored votes sequentially to the central station that serves the particular group. The total votes are stored at each central station until a master station transmits a start signal to the central station. The central station then transmits the results to the master station sequentially.

U.S. Pat. No. 3,858,212 to Tompkins et al. discloses a multi-purpose information gathering and distribution system comprising a central station having an omni-directional antenna for transmitting information queries to a plurality of remote stations and for gathering data acquired at the remote stations that is returned to the central station by the remote stations in response to the information queries. The remote stations are sequentially queried by the central station. In response to the information query, each remote station transmits the conditions at the remote station together with a remote identification code to the central station.

U.S. Pat. No. 4,247,908 to Lockhart, Jr et al. discloses a two-way communication system for use with a host computer that includes a control unit, a base station and multiple, hand-held, portable radio/data terminal units. The control unit interfaces directly with the host computer but uses a radio link to interface with the portable radio/data terminal units. Each portable radio/data terminal unit includes a two-way radio and a data terminal. The data terminal includes a keyboard for data entry and an LED display for readout of either received data or locally generated data. The host computer initiates communication through polling and/or selection of portable radio/data terminal units via the control unit. The control unit, in response to a “poll” from the host computer, answers by sending either a previously received message from a portable radio/data terminal unit, or if no message has been received, a “no message” response. Polling by the control unit is an invitation to the portable radio/data terminal units to send data to the control unit to be stored, grouped if necessary and sent on to the host computer. The control unit polls the portable radio/data terminal units by address in a particular sequence. The control unit transmits acknowledgements to the portable radio/data terminal units for received data on the next polling cycle.

U.S. Pat. No. Re. 35,449 to Derks discloses a remote response system comprising a central control unit that transmits a plurality of distinct address words to remotely located response units and a receiver that receives data words transmitted from response units. Each response unit includes user operable data entry means and a receiver for receiving address words transmitted from the central control unit. Each response unit also includes circuit means for identifying an address word unique to the particular response unit and a transmitter for transmitting data words to the central control unit in response to identification of its unique address word. The central control unit comprises means for determining that a valid data word has been received from a response unit and for transmitting, to the response unit that sent the valid word, an acknowledge message. In response to the received acknowledge message, the particular response unit is conditioned to a second, or “off”, mode. When a response unit has been placed in the “off” mode, the response unit will not respond to its address word again until a new user selection is made.

U.S. Pat. No. 5,002,491 to Abrahamson et al. discloses an interactive electronic classroom system for enabling teachers to teach students concepts and to receive immediate feedback regarding how well the students have learned the taught concepts. Structure is provided for enabling students to proceed in lockstep or at their own pace through exercises and quizzes, responding electronically to questions asked, the teacher being able to receive the responses, and to interpret a readout, in histogram or other graphic display form, of student responses. The electronic classroom comprises a central computer and a plurality of student computers, which range from simple devices to full fledged personal computers, connected to the central computer over a network. Optional peripheral hardware, such as video cassette recorders (VCRs) or other recording/reproducing devices, may be used to provide lessons to students in association with the computer network.

U.S. Pat. No. 5,724,357 to Derks discloses a wireless remote response system comprising a base unit which retrieves user-entered responses from a plurality of remote response units, each of which is provided to a user. The base unit transmits a base data package over a wireless communication link to the plurality of remote response units, which decode the base data packet and load into memory a portion of the decoded base data package at each response unit. Each response unit examines the characters loaded into the memory and determines and processes the characters that pertain to that particular response unit.

U.S. Pat. No. 6,302,698 to Ziv-El discloses a networked teaching and learning system comprising a plurality of student computers, a network server and at least one teacher's computer. The at least one teacher's computer includes comparison and evaluation logic in communication with the student computers for comparing and evaluating each student keystroke with the characters of an answer, if any, immediately after every student keystroke. The teaching and learning system provides character-by-character evaluation for quick learning feedback for students, as well as simultaneous observation at the teacher's computer of multiple student responses identified as correct or incorrect. The teaching and learning system enables quick construction of various exercise types, the scoring of unanticipated responses, and the introduction of an explanation component in addition to a direct response to a question.

U.S. Pat. No. 6,790,045 to Drimmer discloses a method and system for analyzing student performance by classifying student performance into discrete performance classifications associated with corresponding activities related to an electronic course. An observed student performance level for at least one of the performance classifications is measured. A benchmark performance level or range is established for one or more of the performance classifications. It is then determined whether the observed student performance level is compliant with the established benchmark performance level for the at least one performance classification. Instructive feedback is determined for the observed student based upon any material deviation of the observed student performance from at least one benchmark.

U.S. Patent Application Publication No. 2004/0033478 to Knowles et al. discloses a participant response system comprising a plurality of wireless handsets assigned to participants of an event. Each handset has a keyboard for allowing a participant to input a response and has audio capability to allow the participant to receive and input audio. Each handset is configurable either as a participant response handset to allow a participant to enter a response, or as a base station.

U.S. Patent Application Publication No. 2004/0072136 to Roschelle et al. discloses a method and system for assessing a student's understanding of a process that may unfold over time and space. The system comprises thin client devices in the form of wireless, hand-held, palm-sized computers that communicate with a host workstation. The system provides a sophisticated approach of directing students to perform self-explanation, and enables instructors to enhance the value of this pedagogical process by providing meaningful and rapid feedback in a classroom setting.

U.S. Patent Application Publication No. 2004/0072497 to Buehler et al. discloses a response system and method of retrieving user responses from a plurality of users. The response system comprises a plurality of base units and a plurality of response units. Each of the response units is adapted to receive a user input selection and to communicate that user's input selection with at least one base unit utilizing wireless communication. Personality data is provided for the response units to facilitate communication with a particular base unit. The personality data of a particular response unit is changed when it is desired to change the base unit to which that response unit communicates. This allows a response unit to become grouped with a particular base unit at a particular time and become grouped with another base unit at another particular time.

Although the above participant response systems allow test questions to be administered, these participant response systems have proven to be limited as regards question authoring and editing. In prior art participant response systems, each question, each answer choice associated with the question and the answer feedback associated with the question are treated as single objects. As a result, little flexibility is given to teachers with respect to editing questions that have been created. For example, editing questions may require opening and running through the wizard that was used to create the questions or alternatively, the use of third party editing programs to effect question changes. Also, once tests have been created that comprise multiple questions, similar difficulties are encountered if questions in the test are to be re-ordered, cancelled or added.

Microsoft Word® is a common program used by teachers to create questions for tests because it is fast, includes spelling and grammar checking and has many formatting features. Some prior art participant response systems allow tests created in Word® or other text formats to be imported so that the tests can be administered to students. Unfortunately, these participant response systems require the teacher to include keywords in the Word® document to provide the participant response system hints so that the questions therein can be recognized. Also, in prior art participant response systems, questions imported from external databases cannot be previewed before deciding if and where to add the questions to the test. Generally, such prior art participant response systems take a random sample of questions from a large data bank of questions. Although some prior art participate response systems allow teachers to narrow the sample by specifying the number of each kind of question i.e. multiple choice, numeric response, true/false etc., separate software is typically required to refine the imported questions to generate the desired test.

It is therefore an object of the present invention to provide a novel participant response system with a question authoring/editing facility.

### SUMMARY OF THE INVENTION

Accordingly, in one aspect there is provided a participant response system comprising processing structure running an assessment during which participants are prompted to respond to one or more information requests, said processing structure executing a question authoring/editing facility to enable test question authoring, said question authoring/editing facility comprising a monitoring tool for monitoring questions during editing to inhibit creation of invalid questions; and at least one display device communicating with said processing structure and operable to display graphically authored test questions.

According to another aspect there is provided a computer readable medium embodying a computer program for question authoring and editing, said computer program comprising program code for enabling question authoring; program code for enabling question editing; and program code for inhibiting creation of invalid questions.

According to another aspect there is provided a participant response system comprising processing structure running an assessment during which participants are prompted to respond to one or more information requests, said processing structure executing a question authoring/editing facility to enable test question authoring and to enter searchable data associated with each authored question; and at least one display device communicating with said processing structure and operable to display graphically authored test questions.

According to another aspect there is provided a participant response system comprising processing structure running an assessment during which participants are prompted to respond to one or more information requests, said processing structure executing a question authoring facility to enable test question authoring; and at least one interactive display device communicating with said processing structure, said interactive display device operable to receive user input and to recognize user input representing a question.

According to another aspect there is provided an assessment creation tool for a participant response system where during running of an assessment participants are prompted to respond to one or more information requests, said assessment creation tool comprising:

a user interface comprising a main viewing area for presenting pages, at least one of said pages representing an assessment question and a secondary panel presenting user selectable controls for controlling the properties and view of said assessment question;

program code responsive to input resulting from user interaction with one or more of said selectable controls and changing the properties and/or view of said assessment question accordingly.

According to another aspect there is provided a participant response system comprising processing structure running an assessment during which participants are prompted to respond to one or more information requests, said processing structure executing a question authoring/editing facility to enable test question authoring, said question authoring/editing facility comprising an import tool for parsing an imported document to detect and record questions therein; and at least one display device communicating with said processing structure and operable to display graphically authored test questions.

### BRIEF DESCRIPTION OF THE DRAWINGS

Embodiments will now be described more fully with reference to the accompanying drawings in which:

FIG. 1 is a top plan view of a classroom employing a participant response system;

FIG. 2 is a schematic view of the participant response system of FIG. 1;

FIG. 3 is a schematic view of an interactive whiteboard forming part of the participant response system of FIGS. 1 and 2;

FIGS. 4a and 4b are side elevational and top plan views of a receiver forming part of the participant response system of FIGS. 1 and 2;

FIG. 5 is a schematic block diagram of the receiver of FIGS. 4a and 4b;

FIG. 6 is a front plan view of a remote unit forming part of the participant response system of FIGS. 1 and 2;

FIG. 7 is an enlarged front plan view of the remote unit display;

FIG. 8 is a schematic block diagram of the remote unit of FIG. 6;

FIGS. 9 and 10 show a student roster;

FIG. 11 shows a test question displayed on the touch surface of the interactive whiteboard of FIG. 3;

FIG. 12 shows a graphical user interface comprising a main viewing area displaying a question page;

FIG. 13 shows the graphical user interface displaying question page properties; and

FIGS. 14 to 22 show an alternative graphical user interface displaying assessment cover and assessment question pages.

### DETAILED DESCRIPTION OF THE EMBODIMENTS

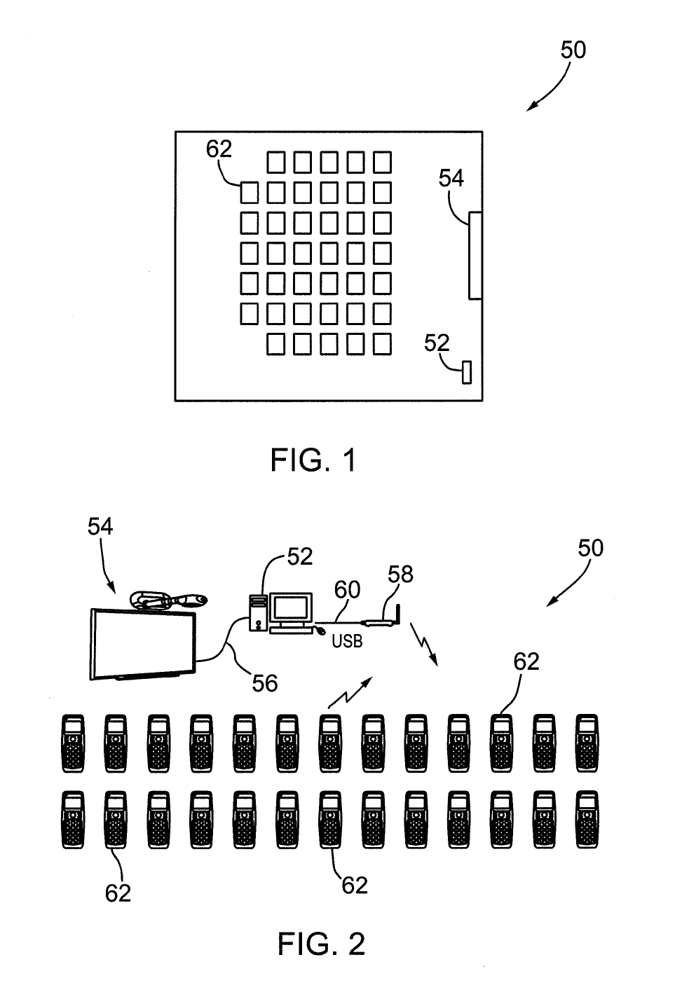

Turning now to FIGS. 1 and 2, a participant response system is shown and is generally identified by reference numeral 50. In this embodiment, participant response system 50 is employed in a classroom, lecture hall or theatre of an educational institution such as for example a school, university, college or the like and is used to create tests, quizzes or assessments (“tests”), administer created tests to a class of students and analyze the results of administered tests. As can be seen, the participant response system 50 comprises a base or host computer 52, an interactive whiteboard (IWB) 54 physically connected to the host computer 52 via a cable 56, a radio frequency (RF) receiver 58 physically connected to the host computer 52 via a universal serial bus (USB) cable 60, and a plurality of wireless, hand-held remote units 62 communicating with the host computer 52 via the receiver 58.

The participant response system firmware in this embodiment is implemented on top of IEEE802.15.4 media access control (MAC) protocol layer software provided by Texas Instruments (TI). The TI MAC protocol layer software comprises a small real-time kernel and a call Z-stack operating system (OS) to provide simple real-time OS facilities such as for example, timer management, task management and interrupt management. Abstraction layers are used to separate the OS and the hardware drivers for ease of porting to a different OS and hardware platform.

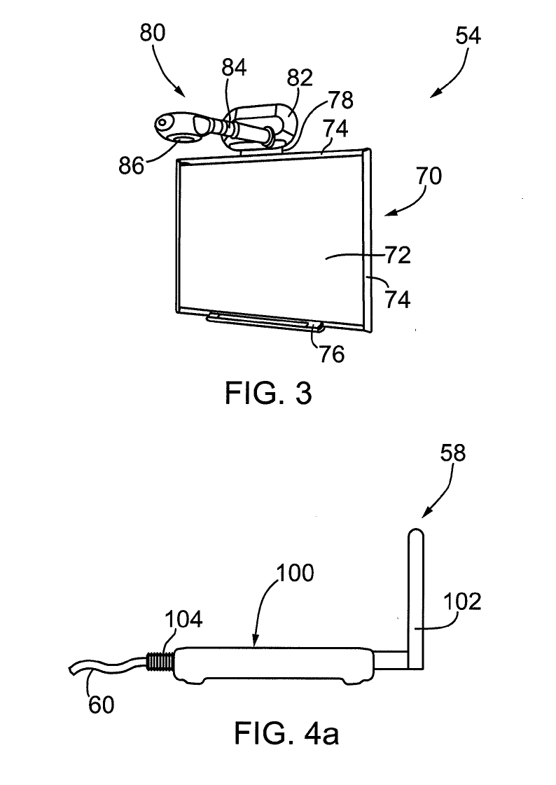

In this embodiment, the IWB 54 is a 600i series interactive whiteboard manufactured by SMART Technologies Inc., of Calgary, Alberta, Canada assignee of the subject application. As is best seen in FIG. 3, the IWB 54 comprises a large, analog resistive touch screen 70 having a touch surface 72. The touch surface 72 is surrounded by a bezel 74. A tool tray 76 is affixed to the bezel 74 adjacent the bottom edge of the touch surface 72 and accommodates one or more tools that are used to interact with the touch surface. The touch screen 70 is mounted on a wall surface via a mounting bracket 78. A boom assembly 80 is also mounted on the wall surface above the touch screen 70 via the mounting bracket 78. The boom assembly 80 comprises a speaker housing 82 accommodating a pair of speakers (not shown), a generally horizontal boom 84 extending outwardly from the speaker housing 82 and a projector 86 adjacent the distal end of the boom 84. The projector 86 is aimed back towards the touch screen 70 so that the image projected by the projector 86 is presented on the touch surface 72.

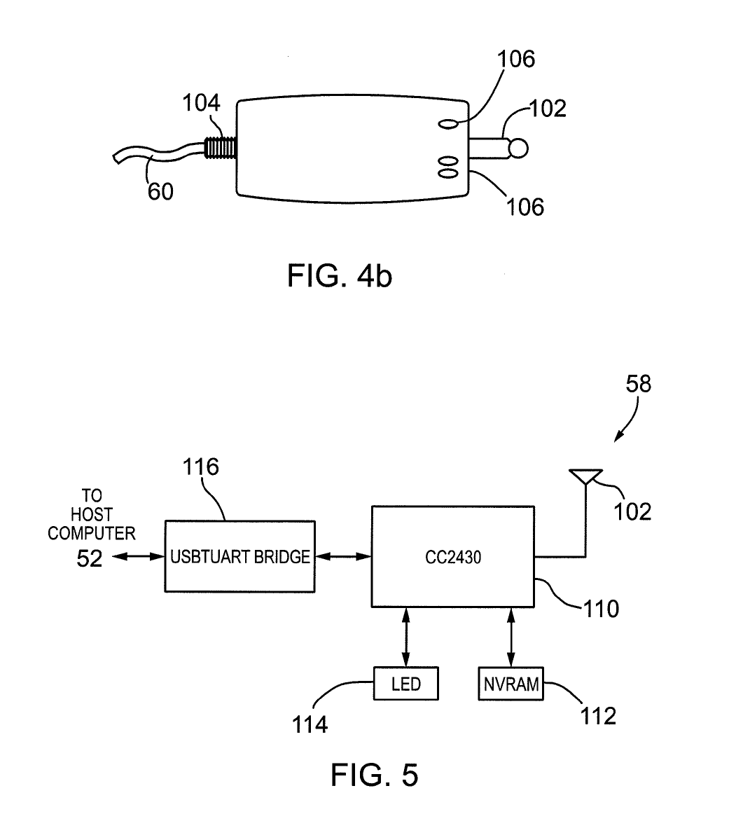

Turning now to FIGS. 4a, 4b and 5, the receiver 58 is better illustrated. As can be seen, the receiver 58 comprises a casing 100 adapted to be desktop or wall mounted. An L-shaped omni-directional antenna 102 is mounted on the front end of the casing 100. The rear end of the casing 100 receives the USB cable 60. A plurality of light emitting diodes (LEDs) 106 is provided on the top surface of the casing 100 with the LEDs being illuminated to provide visual feedback concerning the operational status of the receiver 58. In this embodiment, the LEDs 106 comprise a power status LED and communications status LEDs. Alternatively, the receiver 58 may provide visual feedback via a display such as a liquid crystal display (LCD) or via both LEDs and an LCD. The receiver electronics are accommodated by the casing 100 and comprise a microprocessor 110 that communicates with non-volatile, random access memory (NVRAM) 112, an LED driver 114 and a USB-UART bridge 116. Power is provided to the receiver 58 via the USB connection.

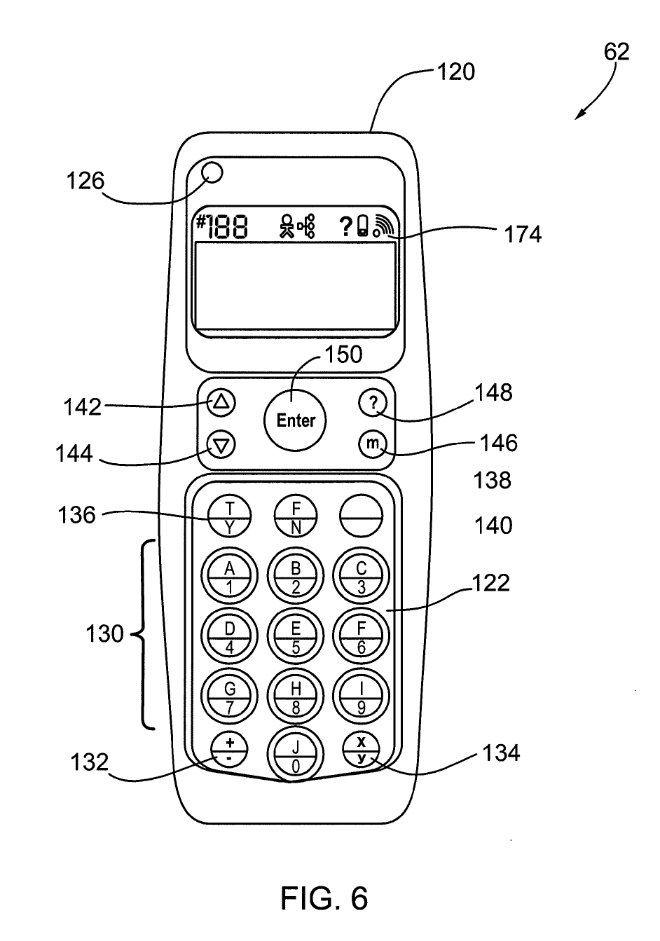

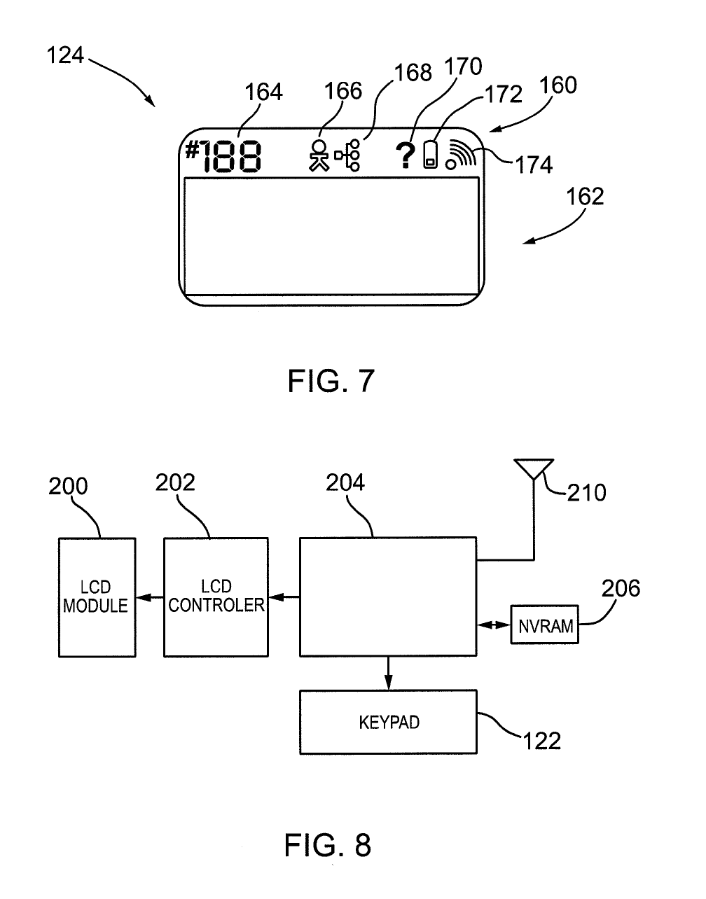

One of the remote units 62 is best shown in FIGS. 6 to 8. As can be seen, the remote unit 62 comprises a casing 120 having a keypad 122, an LCD or other suitable display 124, a power button 126 and an optional battery status LED (not shown) on its front surface. In this embodiment, keypad 122 comprises ten (10) dual character (A to J/O to 9) buttons 130, a plus/minus (+/−) button 132, a fraction/decimal ((x/y)/*) button 134, a true/yes (T/Y) button 136, a false/no (F/N) button 138, a delete (del) button 140, up and down scroll (̂/v) buttons 142 and 144, a menu button 146, a question/hands up (?) button 148 and an enter button 150. Those of skill in the art will appreciate that the form of the keypad shown in FIGS. 6 to 8 is exemplary. The keypad may of course comprise an alternate set of keys, a full QWERTY or DVORAK key set or a subset thereof. If desired, the entire physical keypad or a portion thereof may be replaced with a touch screen overlying the LCD display to allow a user to interact with virtual keys.

The display 124 comprises an upper row of LCD icons 160 disposed above a character display area 162. The LCD icons 160 comprise a question number icon 164, a user status icon 166, a network status icon 168, a hands-up (?) icon 170, a battery status icon 172 and a transmission status icon 174. The character display area 162 comprises a 128×48 pixel array that is divided into three lines 180. Each line 180 can display a total of sixteen (16) characters. Remote unit electronics are accommodated by the casing 120 and comprise an LCD controller 200 that communicates with the display 124, an LCD driver 202 that drives the LCD controller 200, a microprocessor 204 that communicates with the LCD driver 202 and the keypad 122, as well as with NVRAM 206 and a printed circuit board, omni-directional antenna 210. Power is provided to the remote unit 62 by non-rechargeable or rechargeable batteries (not shown) accommodated by the casing. Alternate power sources such as solar sells or manually cranked generators can also be used to power the remote units.

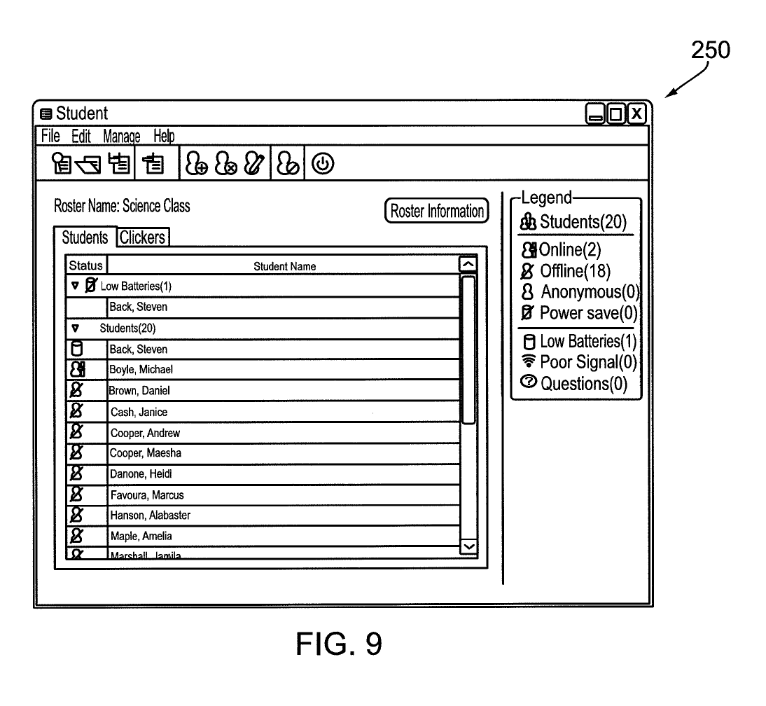

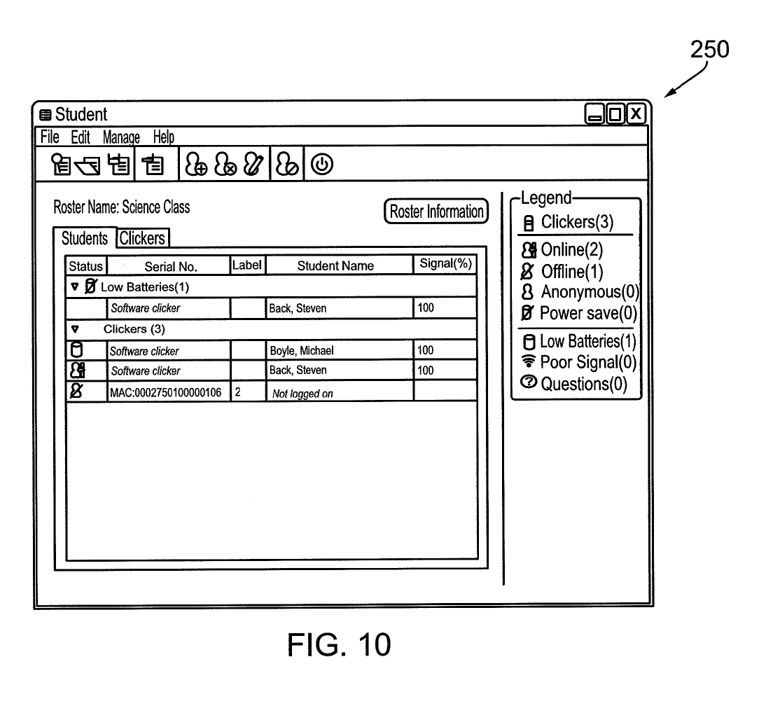

The host computer 52 runs participant response application software comprising a session manager that maintains the state of the participant response system 50. In particular, the session manager maintains a student roster 250 as shown in FIGS. 9 and 10. The student roster 250 identifies the class name, the students in the class by first and last name, the log-in status of the students and whether any of the logged-in students are using a remote device 62 that has a low battery level. The manner by which remote unit battery levels are determined is described in co-pending U.S. patent application Ser. No. ______ to Doerksen et al. entitled “Participant Response System Employing Battery Powered, Wireless Remote Units” filed on even date herewith and assigned to the assignee of the subject application, the content of which is incorporated herein by reference.

The session manager is responsible for downloading the question answer formats e.g. true/false, yes/no, multiple choice, numerical etc. for the questions of the test being administered, to the remote units 62, for receiving answers to questions input by students using the remote units 62 and for keeping track of the question each student is answering. The session manager is also responsible for aggregating answers to questions received from students into results, and grading the answers to the questions.

The host computer 52 also runs SMART Notebook™ whiteboarding software to facilitate interaction with the IWB 54. As a result, the display output of the host computer 52 is conveyed to the IWB and is used by the projector 78 to present an image on the touch surface 72. Pointer interactions with the touch surface 72 are detected by the touch screen 70 and conveyed to the host computer 52. The display output of the host computer 52 is in turn adjusted by the host computer to reflect the pointer activity. The host computer 52 and IWB 54 thus form a closed-loop. Depending on the nature of the pointer activity, the host computer 52 may treat the pointer contacts as writing or erasing or may treat the pointer contacts as mouse events and use the mouse events to control execution of application programs, such as for example the participant response notebook application, executed by the host computer 52. In this manner, the IWB 54 can be used by the instructor to create and administer tests and to analyze test results.

In addition, the participant response application software comprises an administration application that provides a graphical user interface for the session manager to allow the instructor to define and refine test questions, create tests using defined questions, start and stop tests and visualize test results. The administration application also allows question definitions to be imported, allows responses, grades and results to be exported and allows tests to be printed together with answer keys. The administration application has two modes of operation, namely a Notebook integrated mode and a stand-alone mode. In the Notebook integrated mode, the administration application is integrated into the SMART Notebook software. The stand-alone mode is used when the participant response system 50 includes a different brand of IWB 54 or does not include an IWB.

In this embodiment as shown in FIG. 2, the host computer 52, IWB 54 and receiver 58 are physically connected by cables 56 and 60. Messages exchanged between the host computer 52, IWB 54 and receiver 58 are structured using extensible markup language (XML) over HTTP. The receiver 58 and the remote units 62 communicate over a wireless radio frequency (RF) communications network. The microprocessor 110 of the receiver 58 thus provides both a USB interface and an RF interface and runs a service that translates messages in USB protocol to messages in radio frequency (RF) wireless protocol and vice versa as well as IEEE802.15.4 MAC layer software to manage the IEEE802.15.4 network thereby to permit the host computer 52 and remote units 62 to communicate. Messages exchanged between the session manager and the receiver 58 comprise a header, a command identification, message bytes and a checksum. Consistent overhead byte stuffing is employed to provide frame delimiting of packets thereby to facilitate the determination of the start and end of command packets. Messages exchanged between the receiver 58 and the remote units 62 do not include the header and the checksum as the IEEE802.15.4 protocol is used to handle packet addressing and ensure packet integrity.

The messages exchanged between the session manager, the receiver 58 and the remote units 62 include diagnostic messages, status messages and command messages. For example, in this embodiment diagnostic messages comprise, but are not limited to, firmware information query messages, remote unit transmit power query messages and channel identification query messages. Status messages comprise, but are not limited to, remote unit status messages, network status messages and personal area network (PAN) ID messages. Command messages comprise, but are not limited to, log-in messages, log-out messages, log-in grant messages, question download messages, optional answer download messages, answer upload messages, hands-up messages, test start messages and test end messages.

In this embodiment, wireless communications between the host computer 52 and the remote units 62 are carried out according to the IEEE802.15.4 specification, as described in co-pending U.S. patent application Ser. No. ______ to Lam entitled “Participant Response System With Reduced Communications Bandwidth” filed on even date herewith and assigned to the assignee of the subject application, the content of which is incorporated herein by reference.

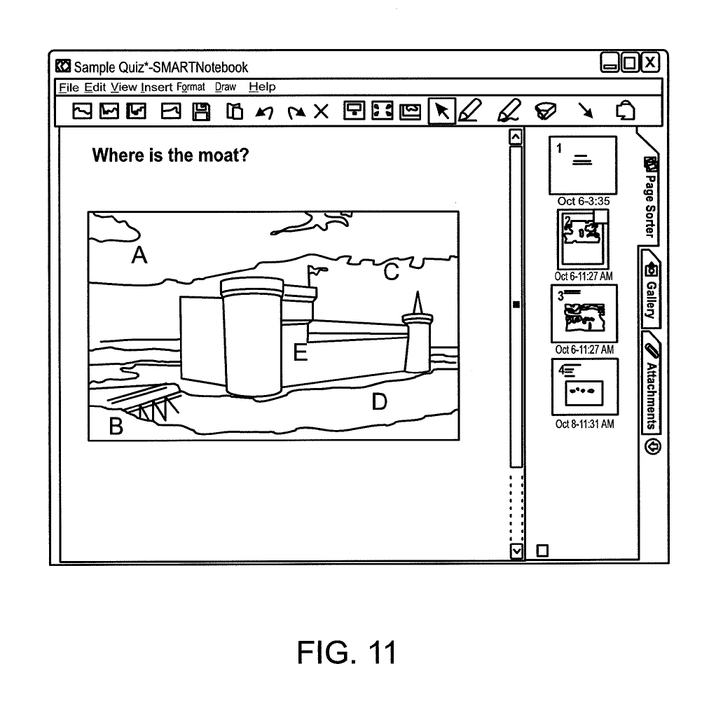

When a test is being administered to students, the session manager generates one or more question download messages that include the question answer formats for the questions of the test. The question download messages are then sent to the receiver 58, which in turn embeds the question download messages in the next beacon frame and broadcasts the beacon frame embodying the question download messages to all of the remote units 62 simultaneously. Upon receipt of the beacon frame, each active remote unit 62 in turn loads the question download messages into memory 206. The student associated with each remote unit 62 can then use the scroll buttons 142 and 144 to select the question to which the student wishes to respond so that the question answer format for the selected question is displayed. The host computer 52 also provides display data to the IWB 54 resulting in the projector 78 projecting the questions of the test on the touch surface 72 of the touch screen 70. In this embodiment, each question is displayed on the touch surface 70 independently as shown in FIG. 11 thereby to facilitate viewing by the students.

When the question is a true/false type question, the question answer format corresponding to the question that is displayed by the remote units 62 provides true and false selections. In this case, the question can be answered using either the true/yes button 136 or the false/no button 138. Likewise, when the question is a yes/no type question, the question answer format corresponding to the question that is displayed by the remote units 62 provides yes and no selections. In this case, the question can be answered using either the true/yes button 136 or the false/no button 138. When the question is a multiple choice or numeric type question, the question answer format corresponding to the question that is displayed by the remote units 62 provides choice selections or a line for the numeric answer. In this case, the question can be answered using the dual character buttons 130, the +/−button 132 and/or fraction/decimal button 134.

When an answer has been input into a remote unit 62 via the keypad 122 and the enter button 150 has been pressed, the remote unit 62 generates an answer upload message that includes the question number and the student's answer and sends the answer upload message to the receiver 58, which in turn passes the answer upload message to the host computer 52. The session manager saves the answer upload message and analyzes the answer thereby to provide results to the administration application.

If desired, the processing capabilities of the remote units 62 can be utilized to grade input answers. In this situation, in addition to command download messages, answer download messages are conveyed to the remote units 62. When a user inputs an answer to a question, the remote unit 62 compares the input answer with the corresponding answer download message and generates an answer upload message comprising one of two values signifying either a correct or incorrect response. As a result, some of the computing load is transferred to the remote units 62 reducing the processing burden placed on the host computer 52. If the system is configured for a practice mode, the remote unit can use the answer download messages to display the results to the user without transmitting answer upload messages to the host computer.

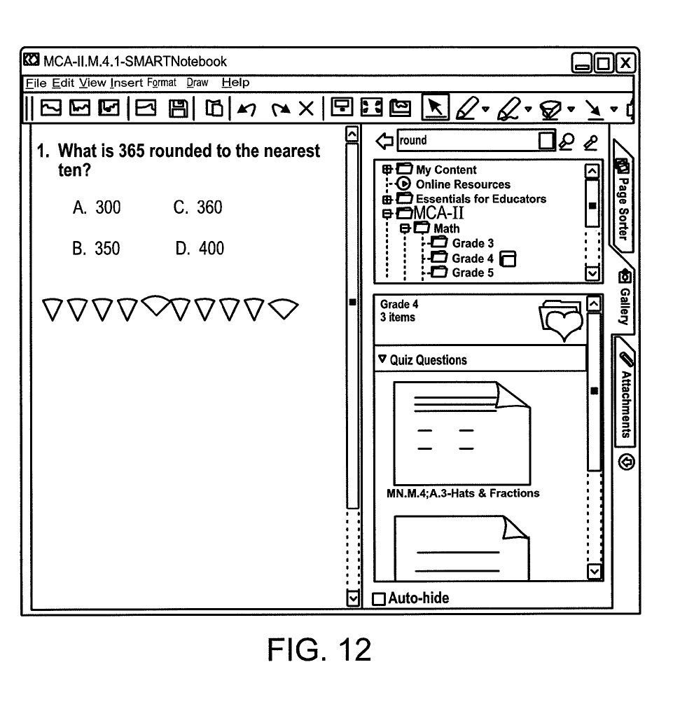

As mentioned above, the administrator application provides a graphical user interface that enables the instructor to create, modify, import and administer tests or assessments. The administration application interacts with a gallery (database) of learning objects and lesson activities including test questions from which a teacher can incorporate multimedia resources into a test that is maintained by the SMART Notebook™ software. In one embodiment, each question is stored on its own page and includes rich metadata associated with the question to facilitate searching and question selection as will be described. As is shown in FIG. 12, the graphical user interface provides a large main viewing area or pane for displaying questions in the gallery that may be selected for inclusion in the test. The graphical user interface allows teachers to browse the gallery content by semantic categories as well as to search for content by tags such as for example metadata, keywords, titles etc. The graphical user interface also allows teachers to browse the gallery content by content type such as for example picture, video, notebook page or lesson activity.

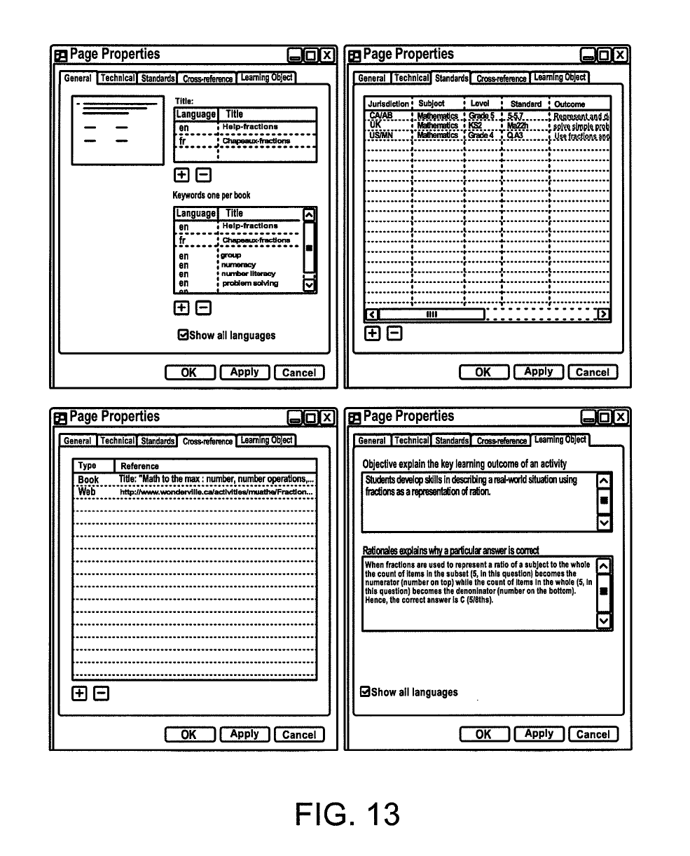

If a particular question appearing in the main viewing area is of interest, underlying property pages concerning the question can be viewed as shown in FIG. 13 thereby to expose the metadata associated with the question. In this embodiment, the metadata includes keywords, tags in multiple languages, multiple curriculum standards, learning objectives and rational that provides an explanation for why a particular answer is correct, and cross-references to text book pages, on-line websites and other media if appropriate. This metadata allows a teacher to evaluate thoroughly a question before selecting the question for inclusion in a test.

As will be appreciated, as the questions in the gallery can be searched semantically or by tags, teachers are able to find questions in the gallery quickly that are geared towards the curriculum standards for the subject, level and topic. As the page properties provide significant detail concerning the questions, the teacher is able to understand readily the learning outcome the questions strive to assess. If the questions are linked to material in a text book or other reference, the page properties inform the teacher where in the text the question relates.

In this embodiment, each page containing a question comprises one question object, a feedback panel object, one or more choice objects as well as answer data. Each of these objects has its own label and location and can be edited and manipulated separately via the administration application graphical user interface. The administration application comprises a monitoring tool that is enabled during question refining in order to prevent a question from becoming invalid. The monitoring tool sets flags as questions are refined that are used by the administration application. During refining of a question, whenever one of the objects of a question is manipulated, the monitoring tool is informed of the change. The monitoring tool in turn examines what has been done to the question objects and ensures that the resultant question is still valid.

In particular during question refining, selecting a choice object or question object allows the body text for that object to be edited. The question number or the label cannot be edited. The question label identifies the type of question e.g. true/false, yes/no, multiple choice or numeric response.

Adding choice objects and removing choice objects requires special handling so that when choice objects are removed, there are no gaps in choices or duplicates in choices. Whenever choice objects are removed, the labels of all of the remaining choice objects are automatically renumbered by the monitoring tool so that the resulting question has consecutive choices. Whenever choice objects are added, they are given new labels by the monitoring tool above the existing choice objects again so that the resulting question has consecutive choices.

If choice objects are added by copying and pasting from other choice objects, the sequence of the choice objects is kept the same. For example, if choice objects A, B and C are copied from another question page and pasted onto a page containing choice objects A, B, C and D, then choice objects A, B and C copied from the question page are re-labelled as choice objects E, F and G in that order by the monitoring tool. When all choice objects are deleted from a question, the question label is changed by the monitoring tool to numerical. When choice objects are added to a numerical question, the question label is changed by the monitoring tool to multiple choice. When choice objects are added to a true/false question or a yes/no question, the question label is changed by the monitoring tool to multiple choice.

Whenever choice objects are added or removed, the correct answer data is kept intact by adjusting it if appropriate. If the question changes significantly the results for the question are automatically cleared by the monitoring tool.

If the teacher creates a test in Word® or other text format or wishes to import the created text file, an import tool is used to import the text file so that it is compatible with the SMART Notebook™ software. When a text file is to be imported and the import tool is selected, the text file is initially opened by the import tool. The paragraphs of the text file are then examined to delineate the numbered paragraphs and thereby identify the questions in the file. Once the numbered questions are identified, each question is examined to determine its type. During this process, the text of the question is examined to determine if the question includes the terms “True/False” or Yes/No”. If so, the question is labelled as a true/false or yes/no question. If the question is not a true/false or yes/no question, the question text is further analyzed to determine if the question text includes labelled choices. If so, the question is labelled as multiple choice. If the question is not labelled as multiple choice, as a default, the question is labelled as numeric.

As will be appreciated from the above, the import tool algorithm seeks to identify questions written in a text file and output them as a questions in a SMART Notebook™ file. The algorithm relies on the paragraph structure and visual formatting cues in the text file to determine what text is part of a question, what kind of question it is (yes/no, true/false, multiple choice and decimal numeric response questions), and if it is a multiple choice question, what text is given for each choice.

The import tool algorithm in this embodiment makes use of the Microsoft Office Word document object model, which is an API provided in a dynamic loadable library that is shipped as part of the Microsoft Office Word product. In particular, the import tool uses the Word document object model to read the text file and split its contents into a sequence of paragraphs, each paragraph having a run of text and some visual formatting cues. In this embodiment the visual cues comprise numbered, lettered, or bulleted list paragraph formatting styles. The Word document object model also splits out drawings and pictures and other visual objects in the text file into separate lists.

During operation, the import tool loads the Word document object model and uses it to open the text file to be imported. The document object model in turn scans the text of the paragraphs for the presence of SQZ “tags” (character sequences such as <Q> that delimit the parts of a question). If tags of this nature are found, the import tool delegates all responsibility for importing the text file to an import module provided by SynchronEyes software offered by SMART Technologies ULC.

If the text file does not contain SQZ tags, pictures in the text file if they exist are processed. In particular each picture is written to a temporary .png image file. The import tool then searches for the paragraph that either contains the picture inline or is the “anchor” paragraph for the picture.

Following the above, the import tool iterates through a loop during examination of each paragraph found by the Word document object model, looking at the visual formatting for the paragraph, the text of the paragraph, and state information i.e. the current parse state that indicates what kind of paragraph the import tool expects to encounter next.

During an iteration, the current parse state is used by the import tool to determine first how to proceed. Depending on the current parse state, the “paragraph format” of the current paragraph under consideration is used to determine how next to proceed. In most cases, a reference to the paragraph is cached in one or more temporary lists, comprising lists for question text and text for each choice in multiple choice questions, and a list for indeterminate text.

In some cases, the current parse state changes, such as when encountering text that is clearly not part of the current question. In some cases, the current paragraph format is compared against the format of a previously encountered paragraph to determine how next to proceed. For example, in some cases where the current parse state changes, a question is written to the .notebook file. The current parse state, the current paragraph format, and the paragraph format of a previously encountered paragraph may be used to determine the question type and how it is to be written to the .notebook file. Additionally, the temporary lists of paragraphs are used to output text to the .notebook file and any temporarily saved .png image files for pictures associated with those paragraphs are also added to the .notebook file and linked in with the page that gives the question text. When the question is written, the temporary lists are cleared and the current parse state and state information default to their initial conditions.

After the loop has been completed for all paragraphs, a final iteration through the loop is performed to catch the ambiguous case represented by a text file ending with a multiple choice question. Following the final iteration, the import tool uses the Word document object model to close the text file and the .notebook file is written to disk.

During grouping of questions forming a test, a cover page is used to bundle the test questions. The cover pages identifies the number of question pages that it is associated with and includes links to each of the pages so that the identified pages can be selected and readily viewed. During creation of a test, a cover page is initially created. The questions to be included in the test associated with the cover page are then selected. During question selection, the cover page automatically detects the selected questions and treats the questions as part of the same test. If test questions are added or removed, the cover page automatically updates itself so that it is consistent with the following question pages.

In this embodiment, the cover page is a flash object and receives XML from the SMART Notebook™ software that describes how many questions it is currently handling. The cover page in turn updates its display appropriately. In order to determine how many questions a cover page is handling, when the SMART Notebook™ software detects a cover page, the SMART Notebook™ software examines the following pages one at a time to determine if the pages are question pages. For each question page encountered, a count is incremented. This process is completed until a non-question page is detected. The monitoring tool is employed to detect when question pages are added to or deleted from a test. The monitoring tool in turn sets flags as question pages are added or deleted, which are used by the cover page thereby to allow the cover page to recalculate its question pages and update its display information.

In the case of matching questions selected for a test, the matching questions are generated as a table that includes first and second columns. The first column is labelled alphabetically and the second column is labelled numerically. The table can be edited to change the number of entries. Pictures and ink can be placed in the table entries for allowing pictures to supplement the entry descriptions. When matching questions form part of a test and are dispatched to remote units in a question download message, the matching question is presented on the active remote unit display as a series of lines. For example, the series of lines may be labelled as A-, B- and C-. In order to respond, the students use the remote unit keypads to enter numbers corresponding to the subject matter that matches the column entries.

The administration application also allows the teacher to write a question on the touch screen 70 of the IWB 54. The IWB 54 includes software that monitors the pointer input in the background and performs handwriting recognition as the input ink is drawn. During the handwriting recognition process, the ink is not affected and any recognized text is not displayed. When a question is detected either by detecting a question mark (?) gesture or by parsing the recognized text and recognizing a question, the monitoring software determines the format of the question e.g. yes/no, true/false, multiple choice, numerical, the number of options available if the question is multiple choice and the text associated with the question and the choices. If the question is successfully recognized, an icon is added to the image presented on the IWB touch surface 72 which can be selected by the teacher. When the icon is selected, the administration software communicates with the session manager. The session manager in turn transmits a corresponding question download message to the remote units 62 so that the students may answer the question.

If desired, the administration software can send the question download message immediately to the remote units 62 once the question is detected. If desired, rather than looking for a gesture, a specified region of the touch surface 70 may be designated for question input so that whenever input ink is entered into that touch surface region, the input is recognized and treated as a question.

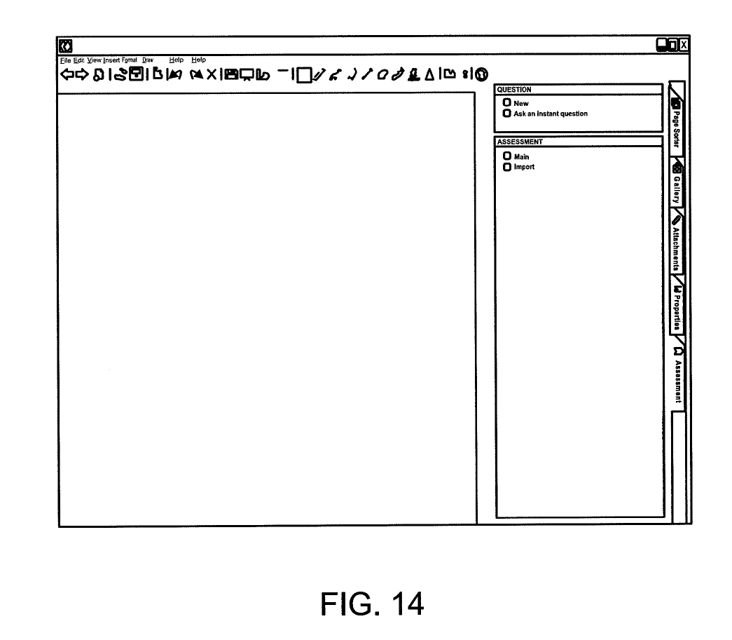

Turning now to FIG. 14, another embodiment of the graphical user interface employed by the administration software to enable a teacher to create tests or assessments as well as questions for the tests and assessments is shown. As can be seen, the graphical user interface comprises a main viewing area or panel and a side panel having associated tags of different categories that can be selected to present different information in the side panel. In this embodiment, the tags include a SMART Notebook PageSorter tag and Gallery tag, an attachments tag, a properties tag and an assessment tag. As shown in FIG. 14, when the assessment tag is selected, the side panel presents a question area and an assessment area. The question area comprises selectable buttons including a new question button and an ask an instant question button. The assessment area includes a new assessment button and an import button.

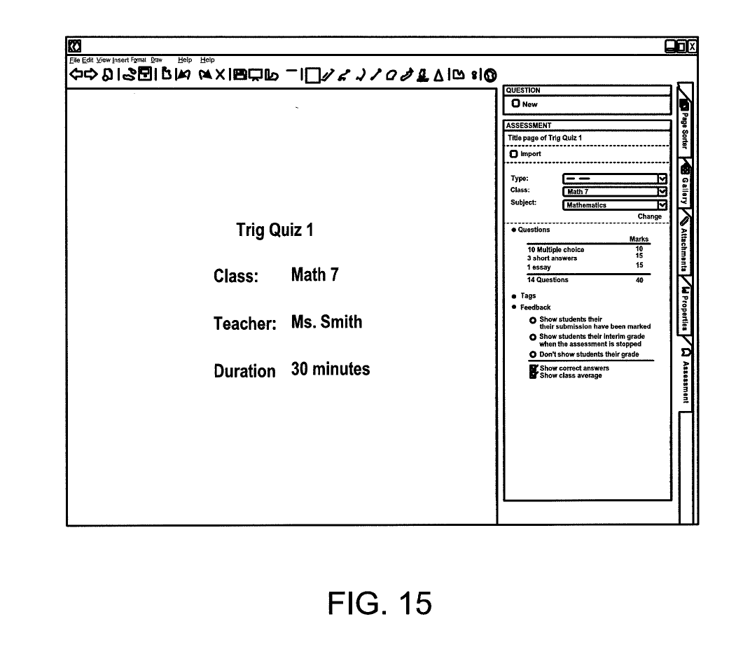

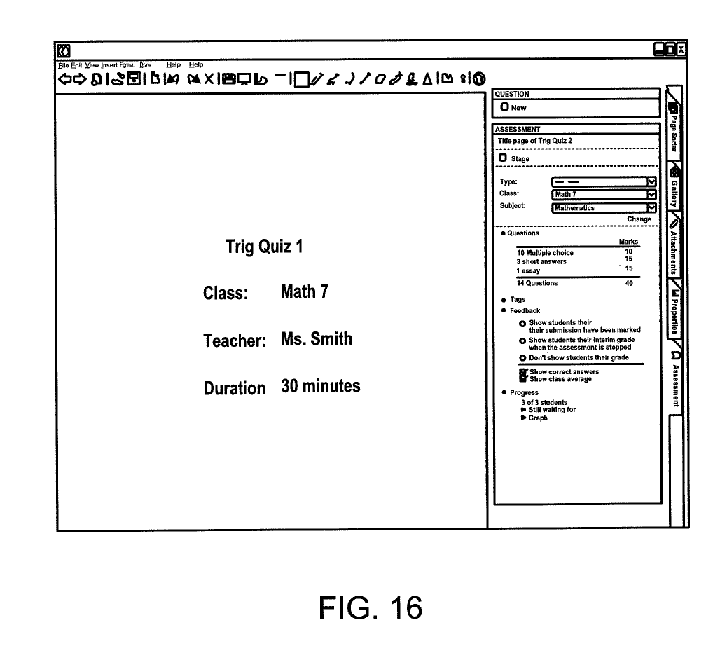

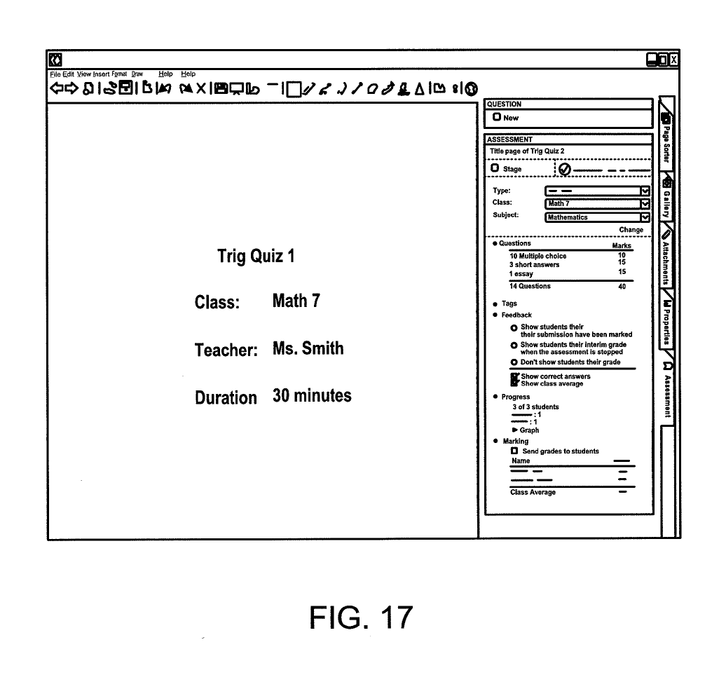

FIG. 15 shows the user interface displaying the first or cover page of an assessment. As can be seen, the assessment cover page displays information associated with the assessment. Similarly, the assessment area of the side panel provides information concerning the assessment including assessment type, class and subject, the number of each type of question in the assessment and the total number of assessment questions, and the type of feedback if any to be provided to students when answering the questions. During an assessment, the assessment area in the side panel provides student progress information as shown in FIG. 16. When the assessment has been completed, the assessment area of the side panel shows the results at different levels and provides the option to have the results transmitted to the students as shown in FIG. 17.

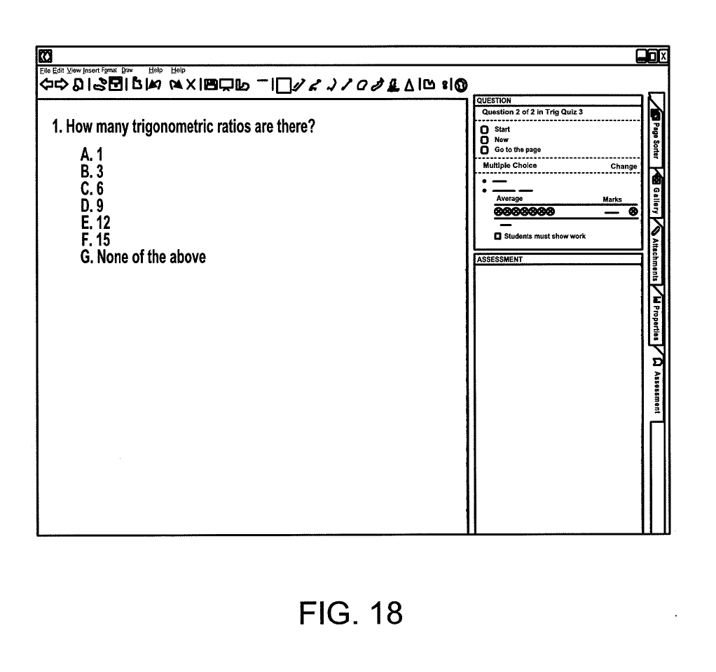

FIG. 18 shows an assessment question displayed in the main viewing area as well as the information displayed in the question area of the side panel associated with the displayed question. In this case, the question area indicates the mark(s) allotted to the question, and an answer key that allows the teacher to designate the correct answer and assign the mark or marks to be allotted to the question.

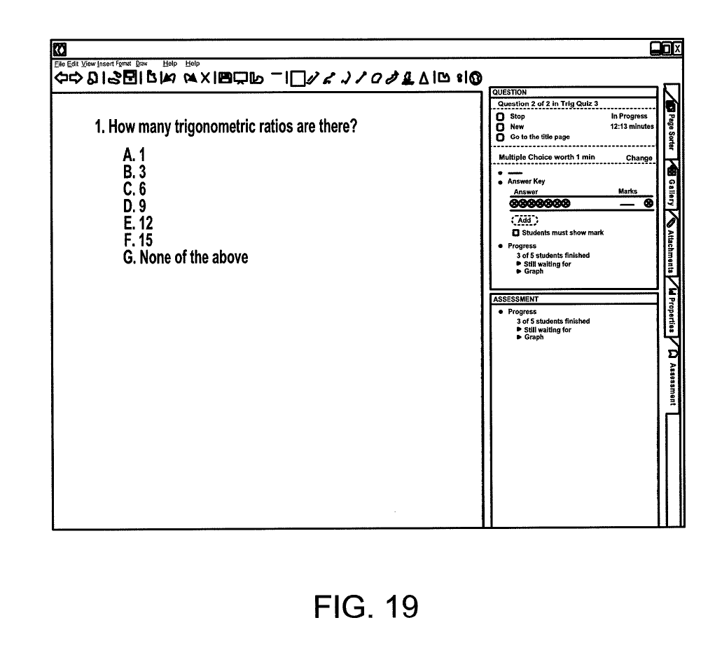

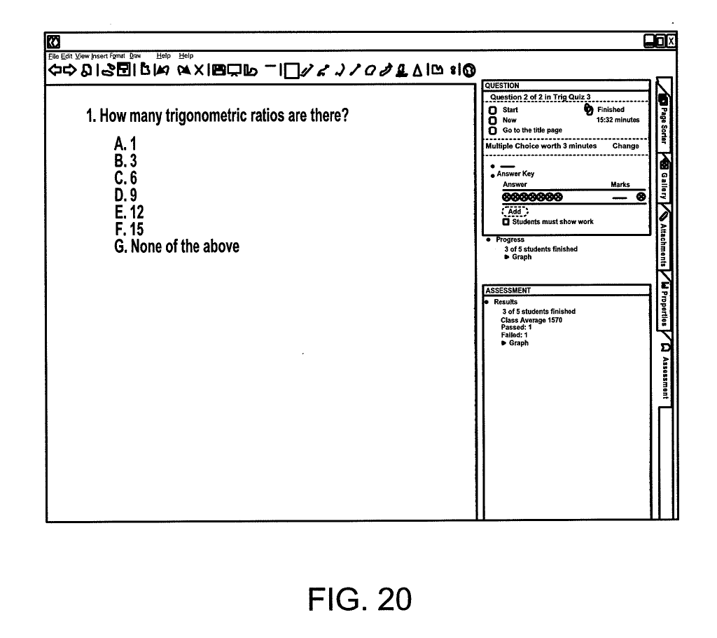

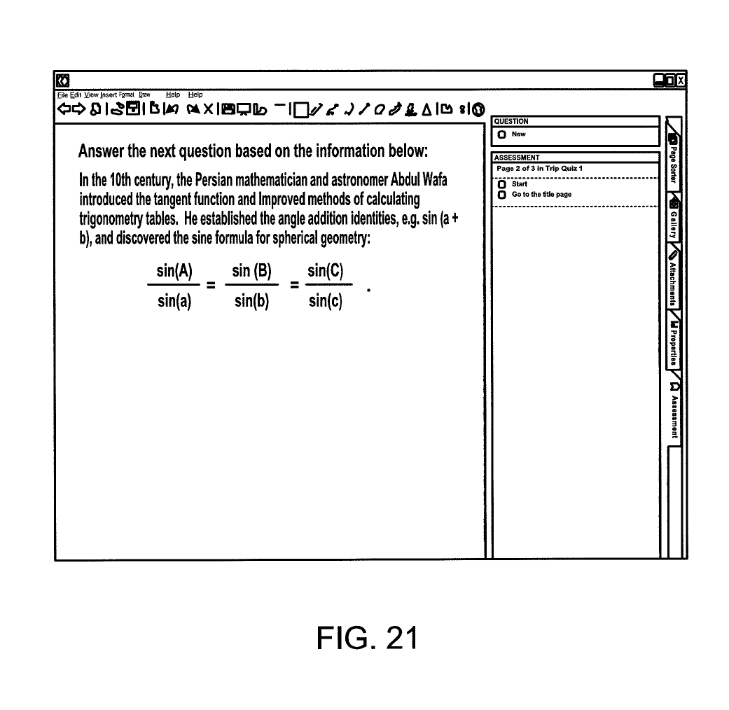

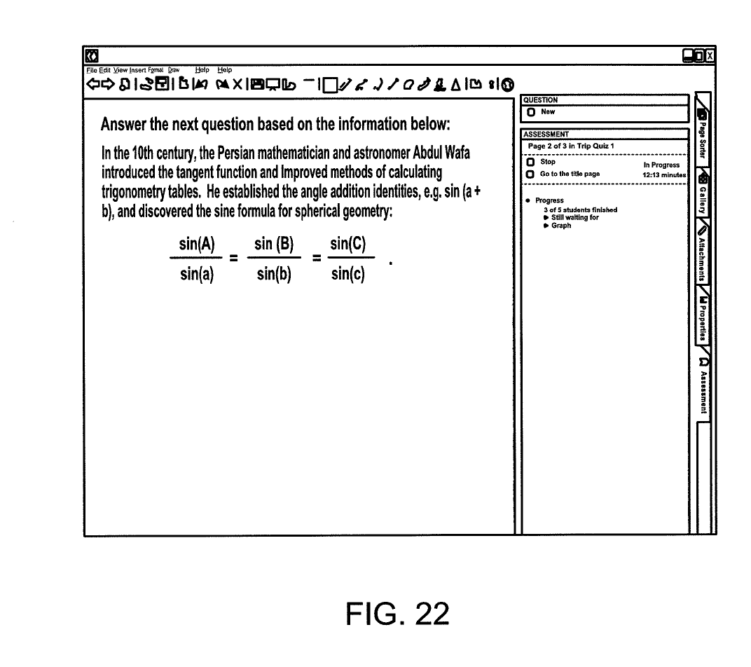

FIG. 19 shows the question page during running of the assessment. In this case, both the question area and the assessment area provide progress information as shown in FIG. 19. FIG. 20 shows the question page after the question has been answered. As can be seen, the question area and assessment area of the side panel provide the results. FIG. 21 shows information displayed on the main viewing area that is part of an assessment but is not a question. During running of the assessment, the assessment area of the side panel still provides assessment progress information.

The participant response system configuration specifics described above are exemplary and as will be appreciated by those of skill in the art, variations are possible. For example, the receiver 58 and remote units 62 can communicate according to the ZigBee specification. The receiver 58 and the host computer 52 can communicate over other wired communication links such as RS-232 or Ethernet connections or over a wireless communication link. Alternatively, the receiver 58 may be integrated into the host computer 52 such that the host computer 52 and remote units 62 communicate directly over a wireless communication link via a compatible wireless protocol such as for example Zigbee, Z-Wave, ANT, IEEE802.11b/g/n or Bluetooth™.

Although a particular form of remote unit 62 is illustrated and described, those of skill in the art will appreciate that the remote units may take a variety of forms. For example, the remote units 62 may be cellular phones, personal digital assistants (PDAs), ultra-mobile personal computers, laptop computers, portable media devices with wireless capability or other suitable devices that allow users to input responses to questions. Of course, combinations of the above devices are permissible so that each user is not required to use the same input device.

Although the IWB 54 is described as including an analog resistive touch screen, those of skill in the art will appreciate that other types of touch screens, such as for example camera-based, surface acoustic wave, capacitive etc. touch screens may be used. Alternatively, the questions can be projected onto a non-interactive display surface or delivered to students on handouts. In either case, the instructor interacts with the administration application via the monitor of the host computer.

Those of skill in the art will appreciate that although a single classroom employing the participant response system 50 has been shown, in a typical education environment, participant response systems are employed in many, if not all classrooms of the educational institution. Of course, the participant response system 50 may be used in other environments where individuals are required to input responses to be processed.

As described above, the participant response system 50 provides for various advantages that achieve greater operability and user-friendliness. For example, one of the advantages is that all questions and answers are preferably broadcast from the teacher to the students. Logged-in students will thus receive the test and answers. Each student can then work at his/her own pace, and that pace is preferably not controlled by the teacher. Preferably, the teacher can not set software-controlled time limits for responses from either the whole class or from an individual student, so each student can advance at a comfortable pace. Furthermore, since the students preferably can not provide narrative responses, tests will be more efficiently conducted. Another advantage is that the participant response system preferably does not allow the student to operate more than one interactive program at a time. This keeps the student's attention focused on the test at hand. Further, the remote units 62 preferably do not decode a teacher data packet that includes a plurality of characters, a portion of which pertain to different remote units. Also, since the IEEE802.15.4 specification is used, which implements a direct sequence spread spectrum modulation scheme, the communication link from the teacher is not subject to variation in timing between the rising and falling edges of the signal. Thus, the remote units are less susceptible to interference and RF noise.

Furthermore, the host computer 52 persistently stores partial test results until the entire test is complete. Preferably, an open session between students and teacher is maintained until the test is complete. In no case is information from one test section included in information regarding another test section transmitted to the teacher. This gives each student greater flexibility in responding to the test, and increases the robustness of the communication protocol. In the participant response system, preferably, the remote units do not immediately transmit each student keystroke of a multi-character response without waiting for the next keystroke. The entire response is sent when completed. Preferably, the participant response system 50 can not be used in a multi-teacher environment, to avoid confusion in which the teacher has control over the test. Also, when authoring a test, the teacher does not place answers in an answer buffer, does not strip answers from a message, and does not leave a designated blank space in place of each answer or selected character.

In the participant response system 50, the remote units do not store an application-specific text file, and they are not programmed to be used for a plurality of different applications solely by modifying such input text file. Likewise, the remote units do not have any structure or function for identifying a particular one address word (assigned to that particular remote unit) from a list of address words sequentially broadcast by the teacher; nor does the host computer have any structure or function for performing such a broadcast. These provisions allow greater flexibility in the tests the teacher can author and administer in the network communications structure and test distribution architecture.

Although embodiments have been described above with reference to the accompanying drawings, those of skill in the art will appreciate that variations and modifications may be made without departing from the spirit and scope thereof as defined by the appended claims.

What is claimed is:

1. A participant response system comprising:
processing structure running an assessment during which participants are prompted to respond to one or more information requests, said processing structure executing a question authoring/editing facility to enable test question authoring, said question authoring/editing facility comprising a monitoring tool for monitoring questions during editing to inhibit creation of invalid questions; and
at least one display device communicating with said processing structure and operable to display graphically authored test questions.

2. A participant response system according to claim 1 wherein said monitoring tool automatically modifies edited questions to maintain the validity thereof.

3. A computer readable medium embodying a computer program for question authoring and editing, said computer program comprising:
program code for enabling question authoring;
program code for enabling question editing; and
program code for inhibiting creation of invalid questions.

4. A participant response system comprising:
processing structure running an assessment during which participants are prompted to respond to one or more information requests, said processing structure executing a question authoring/editing facility to enable test question authoring and to enter searchable data associated with each authored question; and
at least one display device communicating with said processing structure and operable to display graphically authored test questions.

5. A participant response system according to claim 4 wherein said searchable data is metadata.

6. A participant response system comprising:
processing structure running an assessment during which participants are prompted to respond to one or more information requests, said processing structure executing a question authoring facility to enable test question authoring; and
at least one interactive display device communicating with said processing structure, said interactive display device operable to receive user input and to recognize user input representing a question.

7. A participant response system according to claim 6 wherein user input is recognized as a question in response to an input gesture.

8. A participant response system according to claim 7 wherein said input gesture is a handwritten symbol.

9. An assessment creation tool for a participant response system where during running of an assessment participants are prompted to respond to one or more information requests, said assessment creation tool comprising:
a user interface comprising a main viewing area for presenting pages, at least one of said pages representing an assessment question and a secondary panel presenting user selectable controls for controlling the properties and view of said assessment question;
program code responsive to input resulting from user interaction with one or more of said selectable controls and changing the properties and/or view of said assessment question accordingly.

10. An assessment creation tool according to claim 9 wherein said main viewing area displays a single page at one time, said page representing one of an assessment question and an assessment cover page, said secondary panel comprising an assessment question area associated linked to displayed assessment questions and an assessment area link to displayed assessment cover pages, at least the area of said secondary panel associated with the displayed single page presenting selectable controls.

11. A participant response system comprising:
processing structure running an assessment during which participants are prompted to respond to one or more information requests, said processing structure executing a question authoring/editing facility to enable test question authoring, said question authoring/editing facility comprising an import tool for parsing an imported document to detect and record questions therein; and
at least one display device communicating with said processing structure and operable to display graphically authored test questions.
